(19) United States
(12) Patent Application Publication
(10) Pub. No.: US 2026/0271063 A1
(43) Pub. Date: Sep. 10, 2026

(54) TRANSMISSION STATION, TRANSMISSION METHOD, AND TRANSMISSION PROGRAM

(71) Applicant: NTT, Inc., Tokyo (JP)

(72) Inventors: Akira KISHIDA, Musashino-shi, Tokyo (JP); Kengo NAGATA, Musashino-shi, Tokyo (JP); Yusuke Asai, Musashino-shi, Tokyo (JP); Yasushi TAKATORI, Musashino-shi, Tokyo (JP)

(21) Appl. No.: 18/875,455

(22) PCT Filed: Jun. 22, 2022
(86) PCT No.: PCT/JP2022/024866

§ 371 Date: Dec. 16, 2024

(51) Int. Cl. H04W 74/0816; H04L 1/00; H04L 5/00; H04W 72/0453; H04W 76/15

(52) U.S. Cl. CPC H04W 74/0816; H04L 1/0008; H04L 5/0053; H04W 72/0453; H04W 76/15

(57) ABSTRACT

A transmission station includes a first transmission unit, a second transmission unit, a management unit, and an adjustment unit. The management unit is configured to establish, with a reception station, a multi-link in which a first channel is allocated to the first transmission unit and a second channel is allocated to the second transmission unit, and allocate a first service period to the second channel. The adjustment unit is configured to postpone transmission of first data when a first occupancy period for the first transmission unit to transmit the first data overlaps with the first service period.

### TECHNICAL FIELD

An embodiment relates to a transmission station, a transmission method, and a transmission program.

### BACKGROUND ART

A wireless local area network (LAN) is known as a system that wirelessly connects an access point and a terminal apparatus. The wireless LAN enables a terminal apparatus located in a communication area of an access point to access a network via the access point. The access point and the terminal apparatus may provide a service period for preferentially exchanging low-latency traffic.

### CITATION LIST

### Non Patent Literature

Non Patent Literature 1: IEEE P802.11be™/D1.5, “35.9 Restricted TWT (r-TWT)”, Mar. 18, 2022

### SUMMARY OF INVENTION

### Technical Problem

In order to preferentially exchange low-latency traffic, it is desirable to perform transmission control so that a period of exchange of another traffic does not overlap with the service period.

The present invention has been made in view of the above circumstances, and an object thereof is to provide a wireless communication environment in which low-latency traffic can be preferentially exchanged.

### Solution to Problem

A transmission station according to one aspect includes a first transmission unit, a second transmission unit, a management unit, and an adjustment unit. The management unit is configured to establish, with a reception station, a multi-link in which a first channel is allocated to the first transmission unit and a second channel is allocated to the second transmission unit, and allocate a first service period to the second channel. The adjustment unit is configured to postpone transmission of first data when a first occupancy period for the first transmission unit to transmit the first data overlaps with the first service period.

### Advantageous Effects of Invention

According to the embodiment, it is possible to provide a wireless communication environment in which low-latency traffic can be preferentially exchanged.

### BRIEF DESCRIPTION OF DRAWINGS

FIG. 1 is a block diagram illustrating a configuration of a communication system according to an embodiment.

FIG. 2 is a diagram illustrating an example of link management information of a communication system according to the embodiment.

FIG. 3 is a block diagram illustrating an example of a hardware configuration of an access point according to the embodiment.

FIG. 4 is a block diagram illustrating an example of a hardware configuration of a terminal apparatus according to the embodiment.

FIG. 5 is a block diagram illustrating an example of a functional configuration of the access point according to the embodiment.

FIG. 6 is a diagram illustrating an example of a format of a beacon frame according to the embodiment.

FIG. 7 is a block diagram illustrating an example of a functional configuration of the terminal apparatus according to the embodiment.

FIG. 8 is a block diagram illustrating an example of a functional configuration related to transmission determination processing of the terminal apparatus according to the embodiment.

FIG. 9 is a flowchart illustrating an example of transmission determination processing in a wireless signal processing unit of the terminal apparatus according to the embodiment.

FIG. 10 is a flowchart illustrating an example of transmission determination processing in a transmission timing adjustment unit of the terminal apparatus according to the embodiment.

FIG. 11 is a flowchart illustrating an example of simultaneous transmission candidate selection processing in a transmission timing adjustment unit of the terminal apparatus according to the embodiment.

FIG. 12 is a diagram illustrating a first example of transmission determination processing in a transmission station according to the embodiment.

FIG. 13 is a diagram illustrating a second example of transmission determination processing in the transmission station according to the embodiment.

### DESCRIPTION OF EMBODIMENTS

Hereinafter, an embodiment will be described with reference to the drawings. Note I that in the following description, components having the same functions and configurations will be denoted by common reference signs.

### Embodiment

### 1. Configuration

A configuration of a communication system according to the embodiment will be described.

### 1.1 Communication System

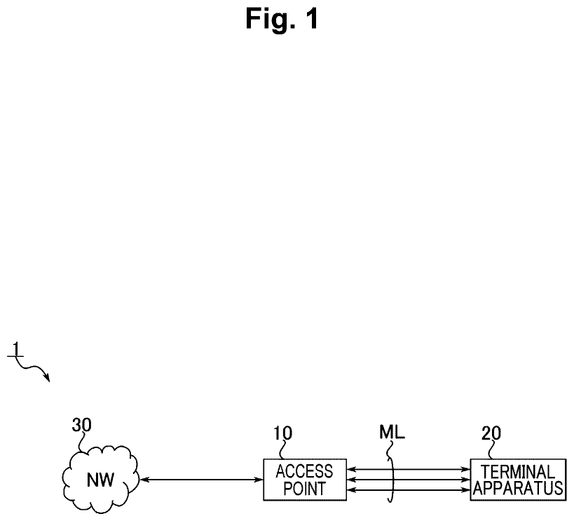

FIG. 1 is a block diagram illustrating an example of the configuration of the communication system according to the embodiment.

As illustrated in FIG. 1, the communication system 1 includes an access point 10, a terminal apparatus 20, and a network 30.

The access point 10 is, for example, a base station of a wireless LAN. The access point 10 is configured to communicate with a server (not illustrated) on the network 30 in a wired or wireless manner. The access point 10 is configured to communicate with the terminal apparatus 20 wirelessly. Communication between the access point 10 and the terminal apparatus 20 is based on, for example, the IEEE 802.11 standard.

The terminal apparatus 20 is, for example, a wireless terminal apparatus such as a smartphone or a personal computer (PC). The terminal apparatus 20 is configured to communicate with the server on the network 30 via the access point 10.

The access point 10 and the terminal apparatus 20 have, for example, a wireless communication function based on an open systems interconnection (OSI) reference model. In the OSI reference model, the wireless communication function is divided into seven layers (the first layer: a physical layer, the second layer: a data link layer, the third layer: a network layer, the fourth layer: a transport layer, the fifth layer: a session layer, the sixth layer: a presentation layer, and the seventh layer: an application layer). The data link layer includes a logical link control (LLC) sublayer and a media access control (MAC) sublayer.

Multi-link ML can be applied to the wireless connection method between the access point 10 and the terminal apparatus 20. The multi-link ML is a wireless connection method capable of transmitting and receiving data (exchanging traffic) by simultaneously using a plurality of links. The access point 10 and the terminal apparatus 20 to which the multi-link ML is applied manage the state of the multi-link ML according to the link management information.

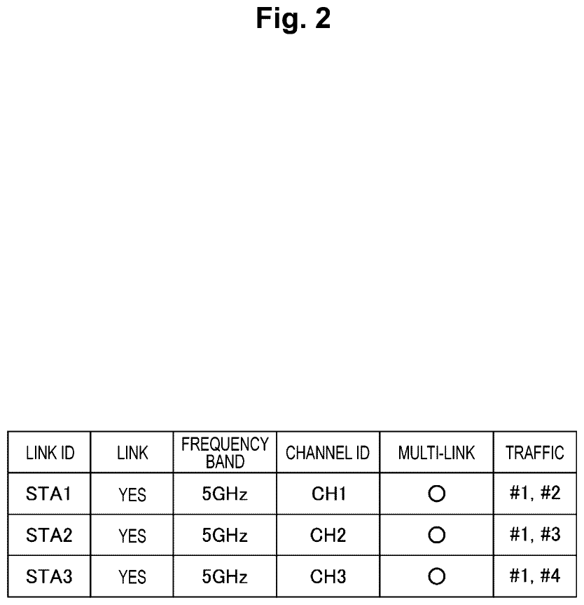

FIG. 2 is a diagram illustrating an example of link management information of a communication system according to the embodiment. The link management information includes, for example, information of each of “link ID”, “link”, “frequency band”, “channel ID”, “multi-link”, and “traffic”.

The “link ID” is an identifier associated with an STA function. The STA function is a functional configuration provided in each of the access point 10 and the terminal apparatus 20 in order to establish a link between the access point 10 and the terminal apparatus 20. That is, a pair of STA functions is used for establishing one link. The example of FIG. 2 illustrates a case where three pairs of STA functions (STA1, STA2, and STA3) are allocated to wireless communication between the access point 10 and the terminal apparatus 20. The STA function corresponds to a wireless signal processing unit described below.

The “link” is information indicating whether or not a link is established between the access point 10 and the terminal apparatus 20 by the STA function. The example of FIG. 2 illustrates a case where all of STA1, STA2, and STA3 have established a link between the access point 10 and the terminal apparatus 20.

“Frequency band” is information indicating a frequency band used for the link. As the frequency band, for example, the 6 GHz band, the 5 GHz band, the 2.4 GHz band, and the like can be applied. Each frequency band includes a plurality of channels. The example of FIG. 2 illustrates a case where the 5 GHz band is allocated to all of STA1, STA2, and STA3.

“Channel ID” is an identifier of a channel used for the link. The example of FIG. 2 illustrates a case where channels CH1, CH2, and CH3 in the 5 GHz band are allocated to STA1, STA2, and STA3, respectively. For example, frequency bands that are so close to each other that power leakage occurs may be allocated to the channels CH1, CH2, and CH3.

The “multi-link” is information indicating whether or not the access point 10 and the terminal apparatus 20 establish the multi-link ML. The example of FIG. 2 illustrates a case where a set of STA1, STA2, and STA3 establishes the multi-link ML.

The “traffic” is information indicating a traffic indicator (TID) allocated to the STA function. The TID is an identifier indicating each traffic, and may be associated with an access category. The access category of the traffic includes, for example, “voice (VO)”, “video (VI)”, “best effort (BE)”, “background (BK)”, and “low latency (LL)”. The access category LL is traffic for which low delay (low latency) is required. Each of TIDS #1 to #4 in FIG. 2 corresponds to, for example, any of the access categories VO, VI, BE, BK, and LL. The example of FIG. 2 illustrates a case where TID #1 is allocated to STA1, STA2, and STA3. In addition, a case where TIDs #2, #3, and #4 are further allocated to STA1, STA2, and STA3, respectively, is illustrated.

As described above, in the multi-link ML, one or a plurality of STA functions can be allocated to one TID.

For example, the association between the traffic and the STA function is set such that a traffic amount is equal among a plurality of links constituting the multi-link ML. Note that the association between the traffic and the STA function is not limited to the above-described example, and for example, traffic of types similar to each other, such as traffic for which low latency is required and traffic for which low latency is not required, may be collected in a specific link constituting the multi-link ML.

The access point 10 and the terminal apparatus 20 have a restricted target wake time (rTWT) function for securing an exchange opportunity of traffic for which low latency is required in the above-described multi-link ML. By using the rTWT function, the access point 10 and the terminal apparatus 20 can set a service period in which exchange of traffic for which low latency is required can be prioritized over traffic for which low latency is not required. Such a service period is also referred to as a rTWT-service period (SP).

### 1.2 Hardware Configuration

Next, hardware configurations of the access point and the terminal apparatus in the communication system according to the embodiment will be described.

### 1.2.1 Hardware Configuration of Access Point

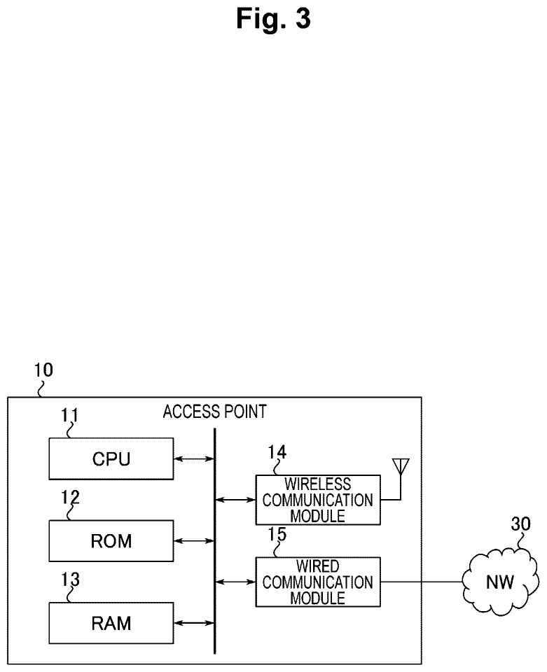

FIG. 3 is a block diagram illustrating an example of a hardware configuration of the access point according to the embodiment.

As illustrated in FIG. 3, the access point 10 includes, for example, a central processing unit (CPU) 11, read only memory (ROM) 12, random access memory (RAM) 13, a wireless communication module 14, and a wired communication module 15.

The CPU 11 is a processing circuit that controls the entire operation of the access point 10. The ROM 12 is, for example, a nonvolatile semiconductor memory. The ROM 12 stores programs and data for controlling the access point 10. The RAM 13 is, for example, a volatile semiconductor memory. The RAM 13 is used as a working area of the CPU 11. The wireless communication module 14 is a circuit used to transmit and receive data by a wireless signal. The wireless communication module 14 is connected to an antenna. The wired communication module 15 is a circuit used to transmit and receive data by a wired signal. The wired communication module 15 is connected to the network 30.

### 1.2.2 Hardware Configuration of Terminal Apparatus

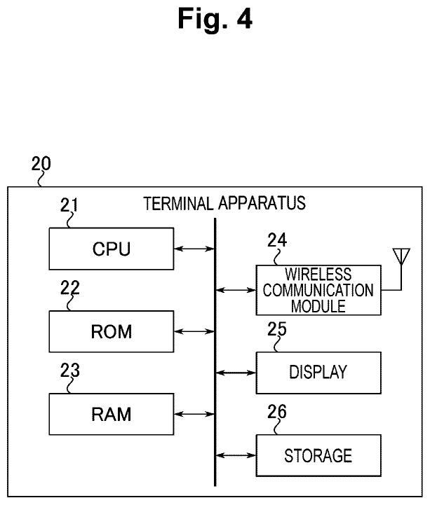

FIG. 4 is a block diagram illustrating an example of a hardware configuration of the terminal apparatus according to the embodiment.

As illustrated in FIG. 4, the terminal apparatus 20 includes, for example, a CPU 21, ROM 22, RAM 23, a wireless communication module 24, a display 25, and a storage 26.

The CPU 21 is a processing circuit that controls the entire operation of the terminal apparatus 20. The ROM 22 is a nonvolatile semiconductor memory. The ROM 22 stores programs and data for controlling the terminal apparatus 20. The RAM 23 is, for example, a volatile semiconductor memory. The RAM 23 is used as a working area of the CPU 21. The wireless communication module 24 is a circuit used to transmit and receive data by a wireless signal. The wireless communication module 24 is connected to an antenna. The display 25 is, for example, a liquid crystal display (LCD) or an electro-luminescence (EL) display. The display 25 displays a graphical user interface (GUI) corresponding to application software, or the like. The storage 26 is a nonvolatile storage device. The storage 26 stores system software and the like of the terminal apparatus 20.

### 1.3 Functional Configuration

Next, functional configurations of the access point and the terminal apparatus in the communication system according to the embodiment will be described.

### 1.3.1 Functional Configuration of Access Point

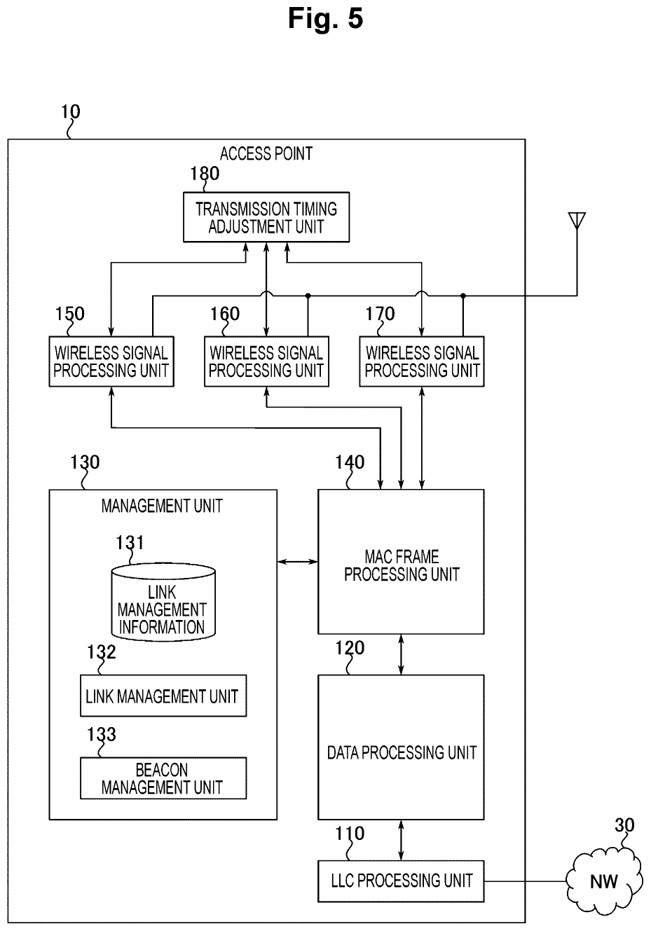

FIG. 5 is a block diagram illustrating an example of a functional configuration of the access point according to the embodiment.

The access point 10 functions as a computer including an LLC processing unit 110, a data processing unit 120, a management unit 130, a MAC frame processing unit 140, a plurality of wireless signal processing units 150, 160, and 170, and a transmission timing adjustment unit 180. The LLC processing unit 110 is a functional block that executes processing corresponding to the LLC sublayer of the second layer and the third layer to the seventh layer. The data processing unit 120, the management unit 130, and the MAC frame processing unit 140 are functional blocks that execute processing corresponding to the MAC sublayer of the second layer. The plurality of wireless signal processing units 150, 160, and 170 and the transmission timing adjustment unit 180 are functional blocks that execute processing corresponding to the MAC sublayer of the second layer and the first layer.

The LLC processing unit 110 adds, for example, a destination service access point (DSAP) header, a source service access point (SSAP) header, and the like to the data received from the network 30 to generate an LLC packet. Then, the LLC processing unit 110 inputs the generated LLC packet to the data processing unit 120. In addition, the LLC processing unit 110 extracts data from the LLC packet input from the data processing unit 120.

Then, the LLC processing unit 110 transmits the extracted data to the network 30.

The data processing unit 120 adds a MAC header to the LLC packet input from the LLC processing unit 110 to generate a MAC frame. Then, the data processing unit 120 inputs the generated MAC frame to the MAC frame processing unit 140. In addition, the data processing unit 120 extracts the LLC packet from the MAC frame input from the MAC frame processing unit 140. Then, the data processing unit 120 inputs the extracted LLC packet to the LLC processing unit 110. Hereinafter, the MAC frame including data is also referred to as a “data frame”.

The management unit 130 manages the state of a link between the access point 10 and the terminal apparatus 20. A MAC frame including management information related to a link, rTWT, and the like is input and output between the management unit 130 and the MAC frame processing unit 140. Hereinafter, the MAC frame including management information is also referred to as a “management frame”. The management unit 130 includes link management information 131, a link management unit 132, and a beacon management unit 133.

The link management information 131 is information related to a link between the access point 10 and the wirelessly connected terminal apparatus 20. The link management information 131 includes, for example, the information illustrated in FIG. 2.

The link management unit 132 controls establishment of a link with the terminal apparatus 20. For example, the link management unit 132 executes association processing and subsequent authentication processing in response to a connection request from the terminal apparatus 20. The link management unit 132 controls the state of a link established with the terminal apparatus 20. For example, the link management unit 132 can determine association between the TID and the STA function in establishing the multi-link ML.

The beacon management unit 133 manages information transmitted as a beacon signal by the access point 10. Specifically, the beacon management unit 133 generates a management frame including management information related to the rTWT function. Then, the beacon management unit 133 inputs the generated management frame to the MAC frame processing unit 140. Hereinafter, the management frame generated by the beacon management unit 133 is also referred to as a “beacon frame”.

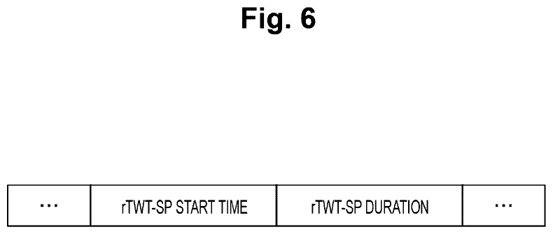

FIG. 6 is a diagram illustrating an example of a format of a beacon frame according to the embodiment. As illustrated in FIG. 6, the beacon frame includes, for example, rTWT-SP start time Ts and rTWT-SP duration D as management information used in the rTWT function.

The rTWT-SP start time Ts is information indicating a time at which the service period rTWT-SP is started. The rTWT-SP duration D is information indicating a length of the service period rTWT-SP. That is, the service period rTWT-SP is set as a period from the rTWT-SP start time Ts to a time when the rTWT-SP duration D has elapsed. The rTWT-SP start time Ts and the rTWT-SP duration D are set for each link. Then, the rTWT-SP start time Ts and the rTWT-SP duration D set for each link are managed by the beacon management unit 133.

Returning to FIG. 5, the functional configuration of the access point 10 will be described.

When a MAC frame is input from the data processing unit 120 or the management unit 130, the MAC frame processing unit 140 associates the MAC frame with a link. For example, when a MAC frame is input from the data processing unit 120, the MAC frame processing unit 140 refers to the link management information 131 to specify a link associated with a TID included in the MAC header. Then, the MAC frame processing unit 140 inputs the MAC frame to the wireless signal processing unit corresponding to the specified link. In addition, when the MAC frame is input from the plurality of wireless signal processing units 150, 160, and 170, the MAC frame processing unit 140 inputs the MAC frame to the data processing unit 120 or the management unit 130 according to the type of the MAC frame. Specifically, when the MAC frame is a data frame, the MAC frame processing unit 140 inputs the MAC frame to the data processing unit 120. When the MAC frame is a management frame, the MAC frame processing unit 140 inputs the MAC frame to the management unit 130.

The plurality of wireless signal processing units 150, 160, and 170 correspond to STA1, STA2, and STA3 in the multi-link ML illustrated in FIG. 2, respectively. Each of the plurality of wireless signal processing units 150, 160, and 170 has an equivalent functional configuration. Each of the plurality of wireless signal processing units 150, 160, and 170 generates a wireless frame by adding a preamble or the like to the MAC frame input from the MAC frame processing unit 140. Each of the plurality of wireless signal processing units 150, 160, and 170 converts the generated wireless frame into a wireless signal. Then, each of the plurality of wireless signal processing units 150, 160, and 170 radiates (transmits) the converted wireless signal via the antenna. The conversion processing from the wireless frame to the wireless signal includes, for example, convolutional encoding processing, interleave processing, subcarrier modulation processing, inverse fast Fourier transform processing, orthogonal frequency division multiplexing (OFDM) modulation processing, and frequency conversion processing. In addition, each of the plurality of wireless signal processing units 150, 160, and 170 converts a wireless signal from the terminal apparatus 20 received via the antenna into a wireless frame. The conversion processing from the wireless signal to the wireless frame includes, for example, frequency conversion processing, OFDM demodulation processing, fast Fourier transform processing, subcarrier demodulation processing, deinterleave processing, and Viterbi decoding processing.

Each of the plurality of wireless signal processing units 150, 160, and 170 extracts the MAC frame from the converted wireless frame. Then, each of the plurality of wireless signal processing units 150, 160, and 170 inputs the extracted MAC frame to the MAC frame processing unit 140.

Note that the plurality of wireless signal processing units 150, 160, and 170 executes transmission determination processing in cooperation with the transmission timing adjustment unit 180 before generation of the wireless frame. The transmission determination processing is processing of determining whether to transmit a data frame. The transmission determination processing includes carrier sense processing. The carrier sense processing is processing of determining the state of a channel used in a link. Details of the transmission determination processing will be described below.

The transmission timing adjustment unit 180 is configured to function when the access point 10 operates as a transmission station. In other words, when the access point 10 operates as a reception station, the transmission timing adjustment unit 180 can be omitted. The transmission timing adjustment unit 180 manages the state related to carrier sense processing in each of the plurality of wireless signal processing units 150, 160, and 170. Then, the transmission timing adjustment unit 180 adjusts the transmission timing of the data frame by each of the plurality of wireless signal processing units 150, 160, and 170 on the basis of the state.

### 1.3.2 Functional Configuration of Terminal Apparatus

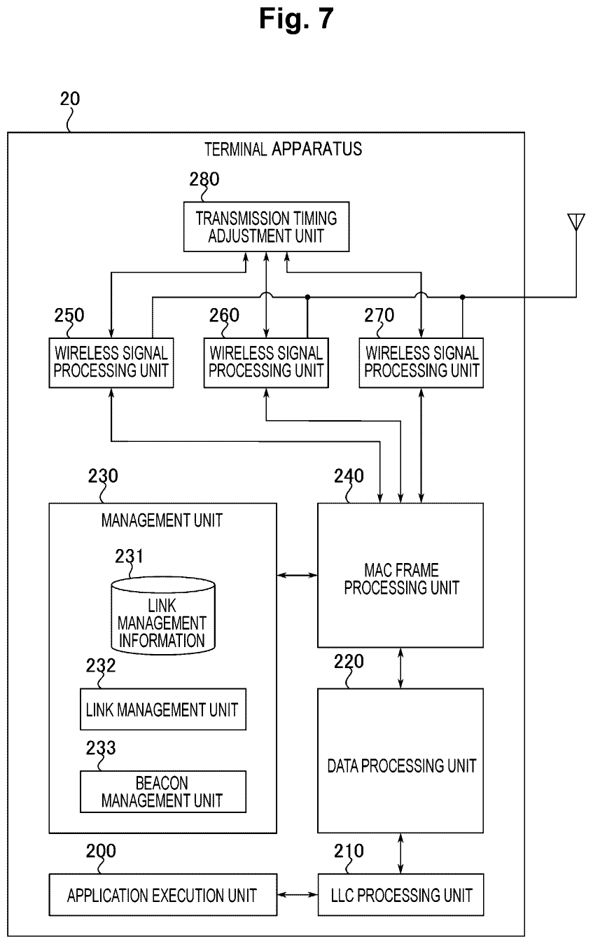

FIG. 7 is a block diagram illustrating an example of a functional configuration of the terminal apparatus according to the embodiment.

The terminal apparatus 20 functions as a computer including an application execution unit 200, an LLC processing unit 210, a data processing unit 220, a management unit 230, a MAC frame processing unit 240, a plurality of wireless signal processing units 250, 260, and 270, and a transmission timing adjustment unit 280. The application execution unit 200 is a functional block that executes processing corresponding to the seventh layer. The LLC processing unit 210 is a functional block that executes processing corresponding to the LLC sublayer of the second layer and the third layer to the sixth layer. The data processing unit 220, the management unit 230, and the MAC frame processing unit 240 are functional blocks that execute processing corresponding to the MAC sublayer of the second layer. The plurality of wireless signal processing units 250, 260, and 270 and the transmission timing adjustment unit 280 are functional blocks that execute processing corresponding to the MAC sublayer of the second layer and the first layer.

The application execution unit 200 executes an application on the basis of data input from the LLC processing unit 210. In addition, the application execution unit 200 inputs data to the LLC processing unit 210. For example, the application execution unit 200 can display application information on the display 25. In addition, the application execution unit 200 can operate on the basis of operation of the input interface.

The LLC processing unit 210 adds a DSAP header, an SSAP header, and the like to data from the application execution unit 200 to generate an LLC packet. Then, the LLC processing unit 210 inputs the generated LLC packet to the data processing unit 220. In addition, the LLC processing unit 210 extracts data from the LLC packet input from the data processing unit 220. Then, the LLC processing unit 210 inputs the extracted data to the application execution unit 200.

The data processing unit 220 adds a MAC header to the LLC packet input from the LLC processing unit 210 to generate a MAC frame. Then, the data processing unit 220 inputs the generated MAC frame to the MAC frame processing unit 240. In addition, the data processing unit 220 extracts the LLC packet from the MAC frame input from the MAC frame processing unit 240. Then, the data processing unit 220 inputs the extracted LLC packet to the LLC processing unit 210.

The management unit 230 manages the state of a link between the access point 10 and the terminal apparatus 20. A MAC frame including management information related to a link, rTWT, and the like is input and output between the management unit 230 and the MAC frame processing unit 240. The management unit 230 includes link management information 231, a link management unit 232, and a beacon management unit 233.

The link management information 231 is information related to a link between the terminal apparatus 20 and the wirelessly connected access point 10. The link management information 231 includes, for example, the information illustrated in FIG. 2.

The link management unit 232 controls establishment of a link with the access point 10. For example, the link management unit 232 executes association processing and subsequent authentication processing when transmitting a connection request to the access point 10. The link management unit 232 controls the state of a link established with the access point 10. For example, the link management unit 232 can determine association between the TID and the STA function in establishing the multi-link ML.

The beacon management unit 233 manages information included in the beacon signal received from the access point 10. Specifically, the beacon management unit 233 extracts management information related to the rTWT function from the beacon frame input from the MAC frame processing unit 240. Then, for example, the beacon management unit 233 manages the rTWT-SP start time Ts and the rTWT-SP duration D within the extracted management information related to the rTWT function for each link.

When a MAC frame is input from the data processing unit 220 or the management unit 230, the MAC frame processing unit 240 associates the MAC frame with a link. For example, when a MAC frame is input from the data processing unit 220, the MAC frame processing unit 240 refers to the link management information 231 to specify a link associated with a TID included in the MAC header. Then, the MAC frame processing unit 240 inputs the MAC frame to the wireless signal processing unit corresponding to the specified link. In addition, when the MAC frame is input from the plurality of wireless signal processing units 250, 260, and 270, the MAC frame processing unit 240 inputs the MAC frame to the data processing unit 220 or the management unit 230 according to the type of the MAC frame. Specifically, when the MAC frame is a data frame, MAC frame processing unit 240 inputs the MAC frame to the data processing unit 220. When the MAC frame is a management frame, MAC frame processing unit 240 inputs the MAC frame to the management unit 230.

The plurality of wireless signal processing units 250, 260, and 270 correspond to STA1, STA2, and STA3 in the multi-link ML illustrated in FIG. 2, respectively. Each of the plurality of wireless signal processing units 250, 260, and 270 has an equivalent functional configuration. Each of the plurality of wireless signal processing units 250, 260, and 270 generates a wireless frame by adding a preamble or the like to the MAC frame input from the MAC frame processing unit 240. Each of the plurality of wireless signal processing units 250, 260, and 270 converts the generated wireless frame into a wireless signal. Then, each of the plurality of wireless signal processing units 250, 260, and 270 radiates (transmits) the converted wireless signal via the antenna. The conversion processing from the wireless frame to the wireless signal includes, for example, convolutional encoding processing, interleave processing, subcarrier modulation processing, inverse fast Fourier transform processing, OFDM modulation processing, and frequency conversion processing. In addition, each of the plurality of wireless signal processing units 250, 260, and 270 converts a wireless signal from the access point 10 received via the antenna into a wireless frame. The conversion processing from the wireless signal to the wireless frame includes, for example, frequency conversion processing, OFDM demodulation processing, fast Fourier transform processing, subcarrier demodulation processing, deinterleave processing, and Viterbi decoding processing. Each of the plurality of wireless signal processing units 250, 260, and 270 extracts the MAC frame from the converted wireless frame. Then, each of the plurality of wireless signal processing units 250, 260, and 270 inputs the extracted MAC frame to the MAC frame processing unit 240.

Note that the plurality of wireless signal processing units 250, 260, and 270 executes transmission determination processing in cooperation with the transmission timing adjustment unit 280 before generation of the wireless frame. The transmission determination processing in the terminal apparatus 20 is processing equivalent to the transmission determination processing in the access point 10.

The transmission timing adjustment unit 280 is configured to function when the terminal apparatus 20 operates as a transmission station. In other words, when the terminal apparatus 20 operates as a reception station, the transmission timing adjustment unit 280 can be omitted. The transmission timing adjustment unit 280 manages the state related to carrier sense processing in each of the plurality of wireless signal processing units 250, 260, and 270. Then, the transmission timing adjustment unit 280 adjusts the transmission timing of the wireless signal by each of the plurality of wireless signal processing units 250, 260, and 270 on the basis of the state.

### 1.3.3 Functional Configuration Related to Transmission Determination Processing

Next, a functional configuration related to transmission determination processing of each of the access point 10 and the terminal apparatus 20 according to the embodiment will be described. Each of the access point 10 and the terminal apparatus 20 functions as a transmission station when executing the transmission determination processing. Specifically, when the access point 10 executes the transmission determination processing, each of the wireless signal processing units 150, 160, and 170 functions as a transmission unit. When the terminal apparatus 20 executes the transmission determination processing, each of the wireless signal processing units 250, 260, and 270 functions as a transmission unit. Hereinafter, as an example, a functional configuration related to the transmission determination processing of the terminal apparatus 20 will be described.

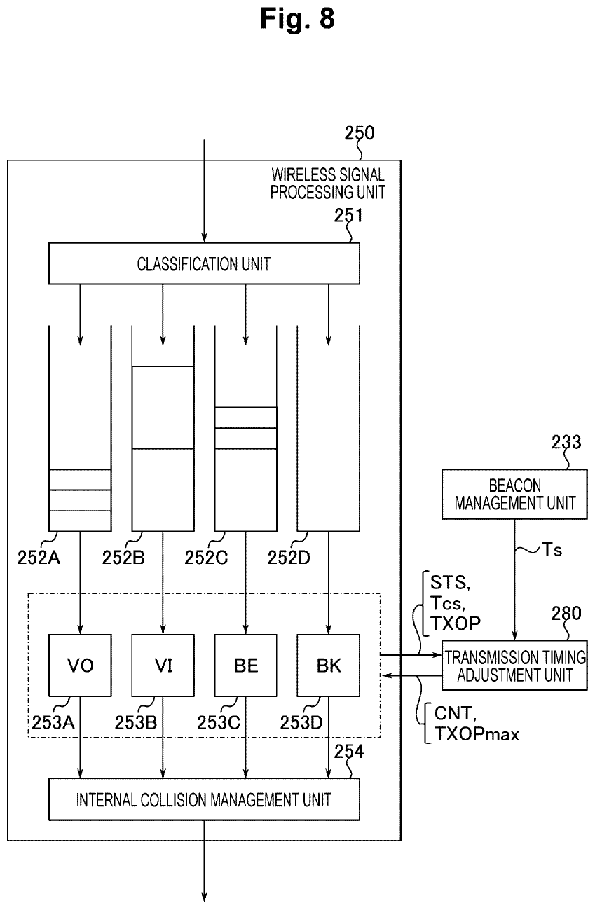

FIG. 8 is a block diagram illustrating an example of a functional configuration related to transmission determination processing of the terminal apparatus according to the embodiment. In the example of FIG. 8, the beacon management unit 233, the wireless signal processing unit 250, and the transmission timing adjustment unit 280 are illustrated. Note that the functional configuration related to the transmission determination processing of each of the wireless signal processing units 260 and 270 is equivalent to the functional configuration related to the transmission determination processing of the wireless signal processing unit 250, and thus the description thereof will be omitted.

The wireless signal processing unit 250 includes a classification unit 251, a plurality of queues 252A, 252B, 252C, and 252D, a plurality of carrier sense units 253A, 253B, 253C, and 253D, and an internal collision management unit 254.

When the MAC frame input from MAC frame processing unit 240 is a data frame, the classification unit 251 classifies the data frame into a plurality of access categories on the basis of a TID included in the MAC header. Then, the classification unit 251 inputs the data frame to the corresponding queue 252 among the plurality of queues 252A, 252B, 252C, and 252D. In the example of FIG. 8, the classification unit 251 inputs data frames corresponding to the access categories VO, VI, BE, and BK to the queues 252A, 252B, 252C, and 252D, respectively.

Each of the plurality of queues 252A, 252B, 252C, and 252D buffers the input data frame. In the example of FIG. 8, the plurality of queues 252A, 252B, 252C, and 252D buffer the data frames corresponding to the access categories VO, VI, BE, and BK, respectively.

The plurality of carrier sense units 253A, 253B, 253C, and 253D correspond to the plurality of queues 252A, 252B, 252C, and 252D, respectively. Each of the plurality of carrier sense units 253A, 253B, 253C, and 253D executes carrier sense processing on the basis of carrier sense multiple access with collision avoidance (CSMA/CA) according to a preset access parameter. In a case where it is determined that a channel is in an idle state for a predetermined time, each of the plurality of carrier sense units 253A, 253B, 253C, and 253D acquires a transmission right of the data frame and ends the carrier sense processing. In a case where it is determined that a channel is in a busy state, each of the plurality of carrier sense units 253A, 253B, 253C, and 253D stops acquisition of a transmission right and ends the carrier sense processing.

As the access parameter used for the carrier sense processing, for example, CWmin, CWmax, Arbitration Inter Frame Space (AIFS), and Transmission Opportunity (TXOP) Limit are used. CWmin and CWmax indicate the minimum value and the maximum value of the contention window, respectively. The contention window is a parameter used to determine a transmission wait time for collision avoidance. AIFS is a fixed transmission wait time set for each access category. TXOPLimit indicates an upper limit value of the channel occupancy period TXOP. That is, for the access category in which shorter CWmin, CWmax, and AIFS are set, it is easier to acquire the transmission right. In addition, for the access category in which larger TXOPLimit is set, the data amount that can be transmitted with one transmission right is larger.

In the carrier sense processing, each of the plurality of carrier sense units 253A, 253B, 253C, and 253D inputs status STS, scheduled transmission right acquisition time Tcs, the channel occupancy period TXOP, and the like of the carrier sense processing to the transmission timing adjustment unit 280. The status STS is information indicating an acquisition situation of the transmission right by the carrier sense processing. The status STS includes, for example, information such as “transmission right is being acquired”, “transmission right acquired”, and “transmission right acquisition stopped”.

A transmission control signal CNT is input from the transmission timing adjustment unit 280 to each of the plurality of carrier sense units 253A, 253B, 253C, and 253D during the carrier sense processing or after the carrier sense processing. The transmission control signal CNT includes, for example, a transmission instruction, a transmission wait instruction, and a transmission postponement instruction. Within the transmission control signal CNT, the transmission instruction and the transmission wait instruction can be input to the carrier sense unit 253 when the transmission right is acquired. On the other hand, the transmission postponement instruction can be input to the carrier sense unit 253 regardless of whether or not the transmission right has been acquired.

In a case where the transmission instruction is input, the carrier sense unit 253 that has acquired the transmission right extracts the data frame buffered in the corresponding queue 252. In a case where the transmission wait instruction is input, the carrier sense unit 253 that has acquired the transmission right waits without extracting the data frame from the corresponding queue 252. In a case where the transmission postponement instruction is input, the carrier sense unit 253 postpones the transmission of the data frame regardless of whether or not the transmission right has been acquired.

Note that when the transmission instruction is input to the carrier sense unit 253 that has acquired the transmission right, the longest channel occupancy period TXOPmax is further input from the transmission timing adjustment unit 280. The longest channel occupancy period TXOPmax is the maximum value of the channel occupancy period TXOP input from each of the wireless signal processing units 250, 260, and 270 to the transmission timing adjustment unit 280. The carrier sense unit 253 to which the transmission instruction has been input adds padding to the data frame extracted from the corresponding queue 252 so as to be equal to the longest channel occupancy period TXOPmax. The data frame to which padding has been added is input to the internal collision management unit 254.

The internal collision management unit 254 prevents collision of transmission in a case where two or more carrier sense units acquire the transmission right simultaneously. Specifically, for example, when a plurality of data frames is simultaneously input, the internal collision management unit 254 preferentially transmits a data frame of an access category with a high priority.

The transmission timing adjustment unit 280 acquires the rTWT-SP start time Ts from the beacon management unit 233. The transmission timing adjustment unit 280 executes simultaneous transmission candidate selection processing on the basis of the rTWT-SP start time Ts, and the status STS, the scheduled transmission right acquisition time Tcs, and the channel occupancy period TXOP input from each of the plurality of wireless signal processing units 250, 260, and 270. The simultaneous transmission candidate selection processing is processing of selecting a candidate of the carrier sense unit 253 to be notified of the transmission instruction.

Specifically, the transmission timing adjustment unit 280 calculates the earliest rTWT-SP start time Tsmin of the carrier sense unit 253 of “transmission right is being acquired” or “transmission right acquired”. In addition, the transmission timing adjustment unit 280 calculates the channel occupancy period end time Te of each of the carrier sense units 253 of “transmission right is being acquired” or “transmission right acquired” on the basis of the scheduled transmission right acquisition time Tcs and the channel occupancy period TXOP. The channel occupancy period end time Te is, for example, a time at which exchange of the data frame to be transmitted and acknowledgement (Ack) corresponding to the data frame ends. Then, the transmission timing adjustment unit 280 adds, as a simultaneous transmission candidate, the carrier sense unit 253 in which the channel occupancy period end time Te is earlier than the earliest rTWT-SP start time Tsmin among the carrier sense units 253 of “transmission right is being acquired” or “transmission right acquired”. In addition, the transmission timing adjustment unit 280 excludes, from simultaneous transmission candidates, the carrier sense unit 253 in which the channel occupancy period end time Te is later than the earliest rTWT-SP start time Tsmin among the carrier sense units 253 of “transmission right is being acquired” or “transmission right acquired”. In a case where the carrier sense unit 253 of “transmission right acquisition stopped” is generated from the simultaneous transmission candidates, the transmission timing adjustment unit 280 executes the simultaneous transmission candidate selection processing again. Then, in a case where all the carrier sense units 253 of the simultaneous transmission candidates become “transmission right acquired”, the carrier sense units 253 as the simultaneous transmission candidates are determined.

When the simultaneous transmission candidates are determined, the transmission timing adjustment unit 280 inputs the transmission postponement instruction to the carrier sense unit 253 excluded from the simultaneous transmission candidates. In addition, the transmission timing adjustment unit 280 calculates the longest channel occupancy period TXOPmax in the carrier sense unit 253 selected as a simultaneous transmission candidate on the basis of the scheduled transmission right acquisition time Tcs and the channel occupancy period TXOP. Then, the transmission timing adjustment unit 280 inputs the transmission instruction and the longest channel occupancy period TXOPmax to the carrier sense unit 253 selected as a simultaneous transmission candidate.

### 2. Operation

Next, an operation in the transmission station of the communication system according to the embodiment will be described.

When the access point 10 is a reception station, the terminal apparatus 20 is a transmission station. When the terminal 20 is a reception station, the access point 10 is a transmission station. Hereinafter, as an example, a case where the terminal apparatus 20 is a transmission station will be described. In addition, in the following description, it is assumed that the multi-link ML based on the link management information illustrated in FIG. 2 is established between the access point 10 and the terminal apparatus 20.

### 2.1 Transmission Determination Processing in Wireless Signal Processing Unit

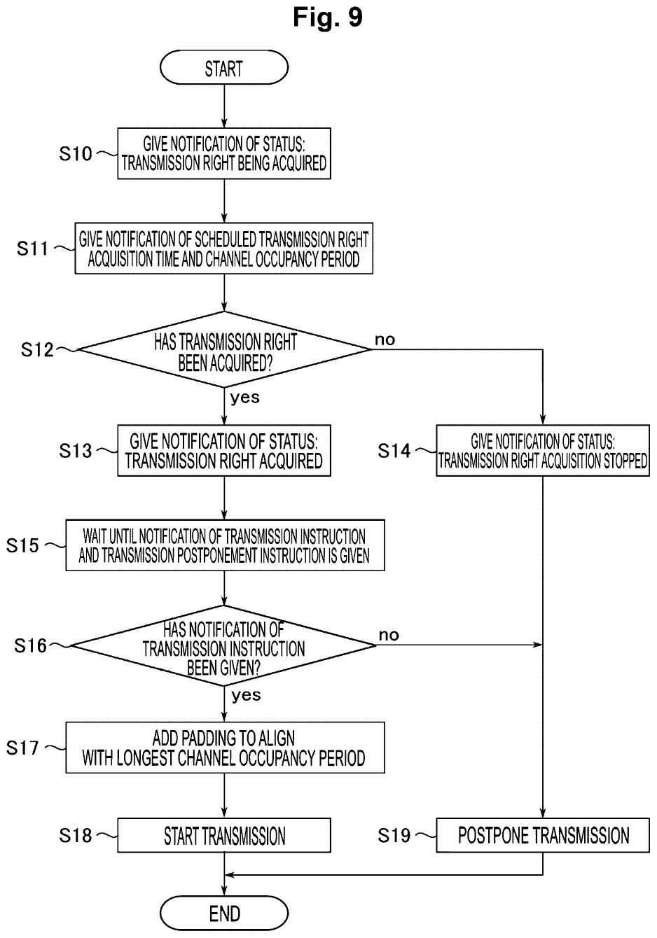

FIG. 9 is a flowchart illustrating an example of transmission determination processing in a wireless signal processing unit of the transmission station according to the embodiment. In the plurality of wireless signal processing units 250, 260, and 270, equivalent transmission determination processing is executed. Hereinafter, the transmission determination processing in the wireless signal processing unit 250 will be described with reference to FIG. 9.

When the carrier sense processing is started (start), each of the plurality of carrier sense units 253A, 253B, 253C, and 253D of the wireless signal processing unit 250 notifies the transmission timing adjustment unit 280 of the status STS “transmission right is being acquired” (S10).

Each of the plurality of carrier sense units 253A, 253B, 253C, and 253D of the wireless signal processing unit 250 notifies the transmission timing adjustment unit 280 of the scheduled transmission right acquisition time Tcs and the channel occupancy period TXOP (S11).

Each of the plurality of carrier sense units 253A, 253B, 253C, and 253D determines whether the transmission right has been acquired (S12).

When the transmission right is acquired (S12; yes), the carrier sense unit 253 that has acquired the transmission right notifies the transmission timing adjustment unit 280 of the status STS “transmission right acquired” (S13).

When the transmission right has not been acquired (S12; no), the carrier sense unit 253 that has not obtained the transmission right notifies the transmission timing adjustment unit 280 of the status STS “transmission right acquisition stopped” (S14).

After the processing of S13, the carrier sense unit 253 that has acquired the transmission right waits until a notification of the transmission instruction or the transmission postponement instruction is given (S15).

When a notification of the transmission instruction or the transmission postponement instruction is given from the transmission timing adjustment unit 280, the carrier sense unit 253 that has acquired the transmission right determines whether the notified transmission control signal CNT is the transmission instruction (S16).

When a notification of the transmission instruction is given (S16; yes), the carrier sense unit 253 of transmission right acquired to which a notification of the transmission instruction has been given extracts the data frame from the corresponding queue 252. Then, the carrier sense unit 253 of transmission right acquired to which a notification of the transmission instruction has been given adds padding to the data frame so that the channel occupancy period TXOP aligns with the longest channel occupancy period TXOPmax notified together with the transmission instruction (S17).

After the processing of S17, the wireless signal processing unit 250 starts transmission of the data frame to which padding has been added (S18). Specifically, the carrier sense unit 253 of transmission right acquired to which a notification of the transmission instruction has been given inputs the data frame to which padding has been added to the internal collision management unit 254. When a plurality of data frames is simultaneously input, the internal collision management unit 254 selects a data frame with high priority. Then, the wireless signal processing unit 250 converts the selected data frame into a wireless signal and transmits the wireless signal to the access point 10.

After the processing of S14 or when a notification of the transmission postponement instruction is given (S16; no), the wireless signal processing unit 250 postpones the transmission of the data frame (S19). Specifically, after the processing of S14, the carrier sense unit 253 that has not acquired the transmission right postpones the transmission of the data frame. When a notification of the transmission postponement instruction is given (S18; no), the carrier sense unit 253 of transmission right acquired to which a notification of the transmission postponement instruction has been given postpones the transmission of the data frame.

After the processing of S18 or the processing of S19, the transmission determination processing in the wireless signal processing unit 250 ends (end).

### 2.2 Transmission Determination Processing in Transmission Timing Adjustment Unit

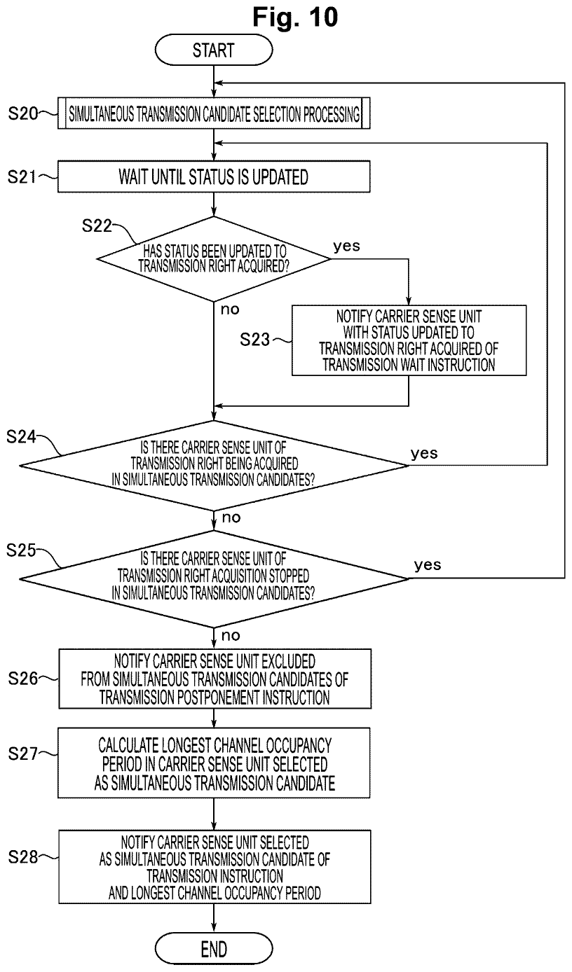

FIG. 10 is a flowchart illustrating an example of transmission determination processing in a transmission timing adjustment unit of the transmission station according to the embodiment.

When the carrier sense processing is started (start), the transmission timing adjustment unit 280 executes simultaneous transmission candidate selection processing (S20). As a result, the transmission timing adjustment unit 280 selects the carrier sense unit 253 as a simultaneous transmission candidate. Details of the simultaneous transmission candidate selection processing will be described below.

After the processing of S20, the transmission timing adjustment unit 280 waits until the status STS “transmission right is being acquired” is updated to “transmission right acquired” or “transmission right acquisition stopped” (S21).

After the processing of S21, the transmission timing adjustment unit 280 determines whether or not the status STS updated during the processing of S21 is updated to “transmission right acquired” (S22).

When the status STS is updated to “transmission right acquired” (S22; yes), the transmission timing adjustment unit 280 notifies the carrier sense unit 253 with the status STS updated to “transmission right acquired” of the transmission wait instruction (S23).

When the status STS is not updated to “transmission right acquired” (S22; no) or after the processing of S23, the transmission timing adjustment unit 280 determines whether or not there is a carrier sense unit 253 with the status STS “transmission right is being acquired” in the simultaneous transmission candidates selected in the processing of S20 (S24).

When there is a carrier sense unit 253 with the status STS “transmission right is being acquired” in the simultaneous transmission candidates (S24; yes), the transmission timing adjustment unit 280 waits until the status STS “transmission right is being acquired” is updated to “transmission right acquired” or “transmission right acquisition stopped” (S21). Then, after the processing of S21, subsequent processing of S22, S23, and S24 is executed. In this manner, the processing of S21 to S24 is repeated until there is no carrier sense unit 253 with the status STS “transmission right is being acquired” left in the simultaneous transmission candidates.

When there is no carrier sense unit 253 with the status STS “transmission right is being acquired” in the simultaneous transmission candidates (S24; no), the transmission timing adjustment unit 280 determines whether or not there is a carrier sense unit 253 with the status STS “transmission right acquisition stopped” in the simultaneous transmission candidates selected in the processing of S20 (S25).

In a case where there is a carrier sense unit 253 with the status STS “transmission right acquisition stopped” in the simultaneous transmission candidates (S25; yes), the transmission timing adjustment unit 280 executes the simultaneous transmission candidate selection processing again (S20). Then, after the processing of S20, subsequent processing of S21, S22, S23, S24, and S25 is executed. In this manner, the processing of S21 to S25 is repeated until there is no carrier sense unit 253 with the status STS “transmission right acquisition stopped” left in the simultaneous transmission candidates.

When there is no carrier sense unit 253 with the status STS “transmission right is being acquired” in the simultaneous transmission candidates (S25; no), the transmission timing adjustment unit 280 notifies the carrier sense unit 253 excluded from the simultaneous transmission candidates by the processing of S20 of the transmission postponement instruction (S26).

The transmission timing adjustment unit 280 calculates the longest channel occupancy period TXOPmax in the carrier sense unit 253 selected as a simultaneous transmission candidate by the processing of S20 (S27).

The transmission timing adjustment unit 280 notifies the carrier sense unit 253 selected as a simultaneous transmission candidate by the processing of S20 of the transmission instruction and the longest channel occupancy period TXOPmax calculated in the processing of S27 (S28).

After the processing of S28, the transmission determination processing in the transmission timing adjustment unit 280 ends (end).

### 2.3 Simultaneous Transmission Candidate Selection Processing

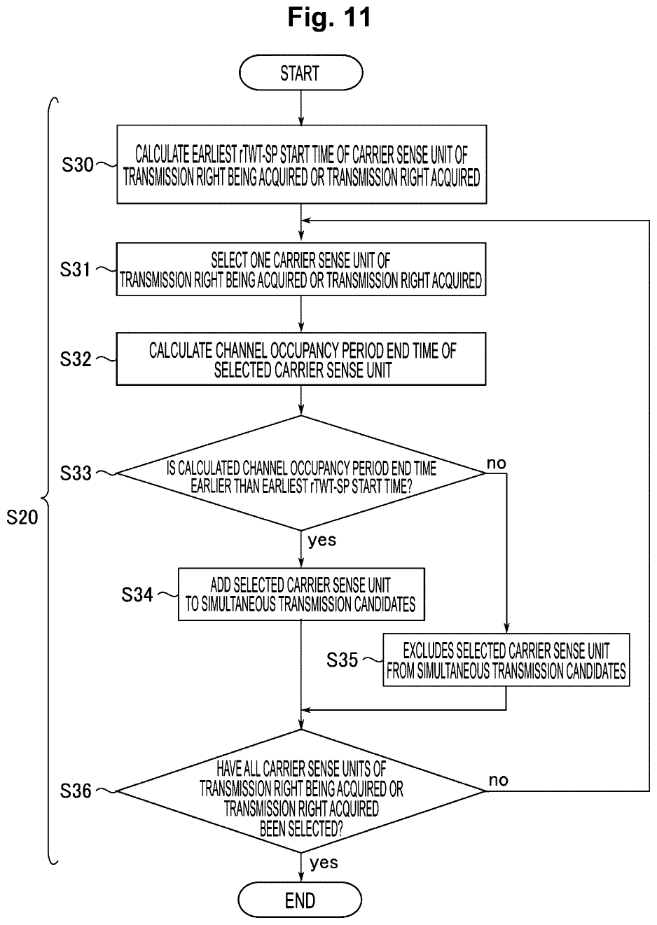

FIG. 11 is a flowchart illustrating an example of simultaneous transmission candidate selection processing in a transmission timing adjustment unit of the transmission station according to the embodiment. The processing of S30 to S36 illustrated in FIG. 11 corresponds to the processing of S20 in FIG. 10.

When the carrier sense processing is started (start), the transmission timing adjustment unit 280 calculates the earliest rTWT-SP start time Tsmin of the carrier sense unit 253 with the status STS “transmission right is being acquired” or “transmission right acquired” (S30).

After the processing of S30, the transmission timing adjustment unit 280 selects one carrier sense unit 253 with the status STS “transmission right is being acquired” or “transmission right acquired” (S31).

The transmission timing adjustment unit 280 calculates the channel occupancy period end time Te of the carrier sense unit 253 selected in the processing of S31 (S32).

The transmission timing adjustment unit 280 determines whether or not the channel occupancy period end time Te calculated in the processing of S32 is earlier than the earliest rTWT-SP start time Tsmin calculated in the processing of S30 (S33).

When the channel occupancy period end time Te is earlier than the earliest rTWT-SP start time Tsmin (S33; yes), the transmission timing adjustment unit 280 adds the carrier sense unit 253 selected in the processing of S31 to the simultaneous transmission candidates (S34).

When the channel occupancy period end time Te is later than the earliest rTWT-SP start time Tsmin (S33; no), the transmission timing adjustment unit 280 excludes the carrier sense unit 253 selected in the processing of S31 from the simultaneous transmission candidates (S35).

After the processing of S34 or the processing of S35, the transmission timing adjustment unit 280 determines whether or not all the carrier sense units 253 with the status STS “transmission right is being acquired” or “transmission right acquired” have been selected (S36).

When there is an unselected carrier sense unit 253 of “transmission right is being acquired” or “transmission right acquired” (S36; no), the transmission timing adjustment unit 280 selects one carrier sense unit 253 with the status STS “transmission right is being acquired” or “transmission right acquired” (S31). Then, subsequent processing of S32, S33, S34, S35, and S36 is executed. In this manner, the processing of S31 to S36 is repeated until all the carrier sense units 253 with the status STS “transmission right is being acquired” or “transmission right acquired” are selected.

In a case where all the carrier sense units 253 of “transmission right is being acquired” or “transmission right acquired” are selected (S36; yes), the simultaneous transmission candidate selection processing ends (end).

### 2.4 Example of Transmission Determination Processing

Next, an example of the transmission determination processing in the transmission station according to the embodiment will be described. Hereinafter, an example of transmission determination processing in a case where the multi-link ML by three pairs of STA functions (STA1, STA2, and STA3) is established in a certain transmission period is illustrated.

### 2.4.1 First Example

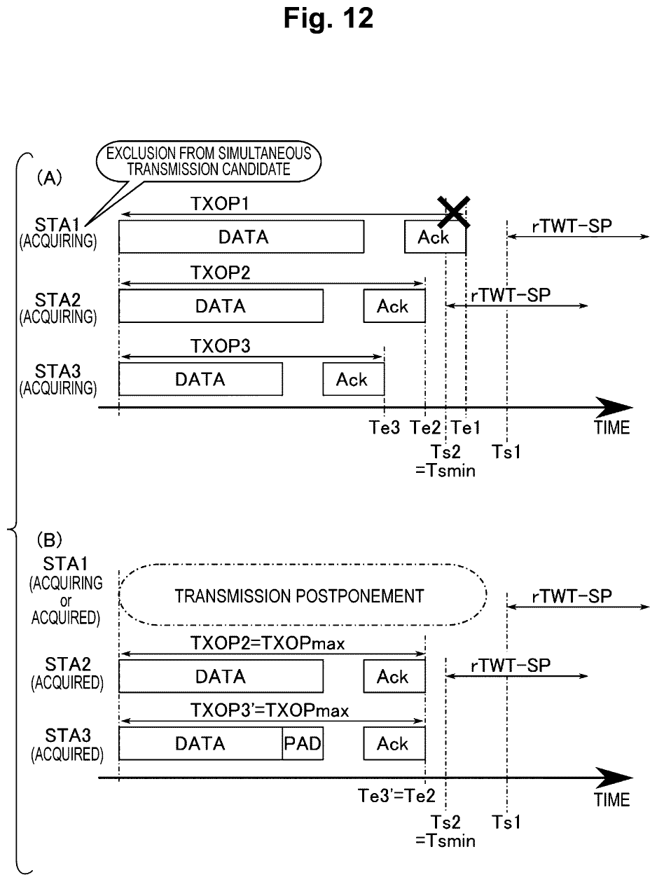

FIG. 12 is a diagram illustrating a first example of transmission determination processing in a transmission station according to the embodiment. The first example corresponds to a case where simultaneous transmission candidates are determined in one-time simultaneous transmission candidate selection processing. In FIG. 12, two situations are illustrated in time series in the order of (A) and (B).

In (A) of FIG. 12, a schedule of each STA function when the simultaneous transmission candidate selection processing ends is illustrated. In (A) of FIG. 12, STA1, STA2, and STA3 are to acquire the transmission right for traffic exchange in the channel occupancy periods TXOP1, TXOP2, and TXOP3, respectively. End time Te1 of the channel occupancy period TXOP1 is later than end time Te2 of the channel occupancy period TXOP2. End time Te2 of the channel occupancy period TXOP2 is later than end time Te3 of the channel occupancy period TXOP3.

In addition, in STA1, the service period rTWT-SP is set from an rTWT-SP start time Ts1. In STA2, the service period rTWT-SP is set from an rTWT-SP start time Ts2 earlier than the rTWT-SP start time Ts1. That is, the transmission timing adjustment unit 280 regards the rTWT-SP start time Ts2 as the earliest rTWT-SP start time Tsmin.

Here, the channel occupancy period end times Te2 and Te3 are earlier than the earliest rTWT-SP start time Tsmin (=Ts2). On the other hand, the channel occupancy period end time Tel is later than the earliest rTWT-SP start time Tsmin (=Ts2). Therefore, as a result of the simultaneous transmission candidate selection processing, the transmission timing adjustment unit 280 adds STA2 and STA3 to the simultaneous transmission candidates and excludes STA1 from the simultaneous transmission candidates.

In (B) of FIG. 12, a schedule of each STA function when the transmission determination processing ends is illustrated. As a result of the carrier sense processing, STA2 and STA3 succeed in acquiring the transmission right. Therefore, the transmission timing adjustment unit 280 extracts the channel occupancy period TXOP2 as the longest channel occupancy period TXOPmax and notifies STA2 and STA3 of the transmission instruction together with the longest channel occupancy period TXOPmax. Each of STA2 and STA3 adds padding to the data frame to align with the longest channel occupancy period TXOPmax. Specifically, STA2 does not add padding because TXOP2=TXOPmax. On the other hand, STA3 adds padding because TXOP3 TXOPmax. As a result, a channel occupancy period end time Te3′ of STA3 is equal to a channel occupancy period end time Te2 of STA2. The channel occupancy period end time Te2 (=Te3′) of STA2 and STA3 is earlier than the earliest rTWT-SP start time Tsmin. Therefore, STA2 and STA3 can execute simultaneous transmission without interfering with the service period rTWT-SP.

Note that, for STA1, as a result of the carrier sense processing, regardless of whether or not the transmission right is acquired, a notification of the transmission postponement instruction is given from the transmission timing adjustment unit 280. Therefore, STA1 postpones the transmission of the data frame.

### 2.4.2 Second Example

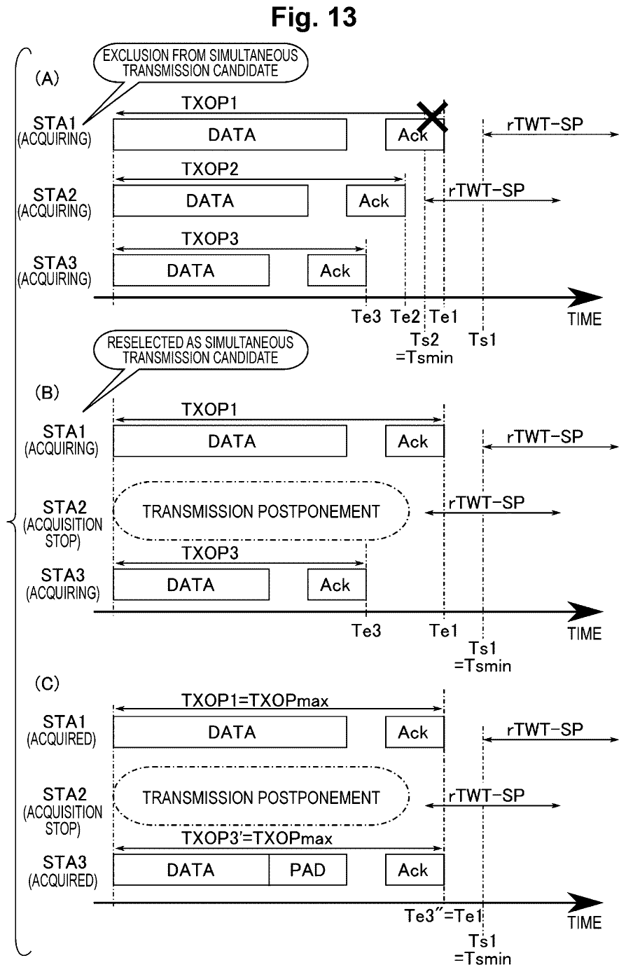

FIG. 13 is a diagram illustrating a second example of transmission determination processing in a transmission station according to the embodiment. The second example corresponds to a case where simultaneous transmission candidates are determined in two times of simultaneous transmission candidate selection processing. In FIG. 13, three situations are illustrated in time series in the order of (A), (B), and (C).

In (A) of FIG. 13, a schedule of each STA function when the first simultaneous transmission candidate selection processing ends is illustrated. In (A) of FIG. 13, STA1, STA2, and STA3 are to acquire the transmission right for traffic exchange in the channel occupancy periods TXOP1, TXOP2, and TXOP3, respectively. The transmission timing adjustment unit 280 calculates the channel occupancy period end time Te on the basis of the channel occupancy period TXOP and the scheduled transmission right acquisition time Tos. End time Te1 of the channel occupancy period TXOP1 is later than end time Te2 of the channel occupancy period TXOP2. End time Te2 of the channel occupancy period TXOP2 is later than end time Te3 of the channel occupancy period TXOP3.

In addition, in STA1, the service period rTWT-SP is set from an rTWT-SP start time Ts1. In STA2, the service period rTWT-SP is set from an rTWT-SP start time Ts2 earlier than the rTWT-SP start time Ts1. That is, the transmission timing adjustment unit 280 regards the rTWT-SP start time Ts2 as the earliest rTWT-SP start time Tsmin.

Here, the channel occupancy period end times Te2 and Te3 are earlier than the earliest rTWT-SP start time Tsmin (=Ts2). On the other hand, the channel occupancy period end time Tel is later than the earliest rTWT-SP start time Tsmin (=Ts2). Therefore, as a result of the first simultaneous transmission candidate selection processing, the transmission timing adjustment unit 280 adds STA2 and STA3 to the simultaneous transmission candidates and excludes STA1 from the simultaneous transmission candidates.

In (B) of FIG. 13, a schedule of each STA function when the second simultaneous transmission candidate selection processing ends is illustrated. As a result of the carrier sense processing, STA2 fails to acquire the transmission right. As a result, STA2 postpones the transmission of the data frame. As a result of the stop of the acquisition of the transmission right by STA2, the transmission timing adjustment unit 280 executes the second simultaneous transmission candidate selection processing in which STA2 is excluded from the simultaneous transmission candidates. That is, the transmission timing adjustment unit 280 regards the rTWT-SP start time Ts1 as the earliest rTWT-SP start time Tsmin. Here, the channel occupancy period end times Tel and Te3 are earlier than the earliest rTWT-SP start time Tsmin (=Ts1). Therefore, as a result of the second simultaneous transmission candidate selection processing, the transmission timing adjustment unit 280 further adds STA1 excluded from the simultaneous transmission candidates in the first simultaneous transmission candidate selection processing to the simultaneous transmission candidates in addition to STA3.

In (C) of FIG. 13, a schedule of each STA function when the transmission determination processing ends is illustrated. As a result of the carrier sense processing, STA1 and STA3 succeed in acquiring the transmission right. Therefore, the transmission timing adjustment unit 280 extracts the channel occupancy period TXOP1 as the longest channel occupancy period TXOPmax and notifies STA1 and STA3 of the transmission instruction together with the longest channel occupancy period TXOPmax. Each of STA1 and STA3 adds padding to the data frame to align with the longest channel occupancy period TXOPmax. Specifically, STA1 does not add padding because TXOP1=TXOPmax. On the other hand, STA3 adds padding because TXOP3<TXOPmax. As a result, a channel occupancy period end time Te3″ of STA3 is equal to the channel occupancy period end time Tel of STA1. The channel occupancy period end time Tel (=Te3″) of STA1 and STA3 is earlier than the earliest rTWT-SP start time Tsmin. Therefore, STA1 and STA3 can execute simultaneous transmission without interfering with the service period rTWT-SP.

### 3. Effects According to Embodiment

In a case where the frequency bands allocated to the plurality of channels constituting the multi-link ML are close to each other, there is a possibility that power leakage occurs between the channels. When power leakage occurs between the channels, it is difficult to perform an operation of transmitting data in one channel and receiving data in the other channel. For example, in a case where data transmission is simultaneously started in a plurality of channels, it is difficult to perform an operation of continuously transmitting data in one channel and receiving Ack of transmission data in the other channel. Therefore, a method of aligning the channel occupancy period end times Te among a plurality of channels constituting the multi-link ML by adding padding is known. However, the addition of padding may cause an unintended overlap between the channel occupancy period TXOP and the service period rTWT-SP. It is not preferable that the channel occupancy period TXOP overlaps with the service period rTWT-SP because low-latency traffic exchange in the service period rTWT-SP may be inhibited.

According to the embodiment, when the channel occupancy period TXOP overlaps with the earliest service period rTWT-SP, the transmission timing adjustment unit 280 excludes the carrier sense unit 253 that is acquiring or has acquired the transmission right of data in the channel occupancy period TXOP from the simultaneous transmission candidates. As a result, the carrier sense unit 253 excluded from the simultaneous transmission candidates can postpone the transmission of data together with the transmission of data by another carrier sense unit 253 that has acquired the transmission right. Therefore, it is possible to suppress inhibition of low-latency traffic exchange in the service period rTWT-SP. Accordingly, it is possible to provide a wireless communication environment in which low-latency traffic can be preferentially exchanged.

In addition, in a case where the carrier sense unit 253 as the simultaneous transmission candidate fails to acquire the transmission right, the transmission timing adjustment unit 280 executes the simultaneous transmission candidate selection processing again. As a result, it is possible to select simultaneous transmission candidates without considering the service period rTWT-SP allocated to the carrier sense unit 253 that has failed to acquire the transmission right. Therefore, the number of STA functions as simultaneous transmission candidates can be increased as compared with a case where the simultaneous transmission candidate selection processing is not executed again.

In addition, the carrier sense unit 253 notified of the transmission instruction adds padding so that its own channel occupancy period TXOP aligns with the longest channel occupancy period TXOPmax. Here, the channel occupancy period TXOP includes a period in which Ack from the reception station is received. As a result, the channel occupancy period end times Te can be aligned among the plurality of channels constituting the multi-link ML. Therefore, it is possible to avoid an operation of transmitting data in one channel and receiving data in the other channel.

In addition, in a case where there is a carrier sense unit 253 of transmission right is being acquired in the simultaneous transmission candidates, the transmission timing adjustment unit 280 notifies a carrier sense unit 253 of transmission right acquired of the transmission wait instruction. As a result, simultaneous data transmission can be executed among a plurality of channels constituting the multi-link ML. Additionally, it is possible to facilitate estimation of padding addition period based on the longest channel occupancy period TXOPmax.

In addition, the wireless signal processing unit 250 transmits data having a lower latency than data transmitted in a period outside the service period rTWT-SP in the service period rTWT-SP. As a result, low-latency traffic can be preferentially exchanged.

In addition, the access point 10 gives a notification of the service period rTWT-SP by a beacon signal. As a result, the terminal apparatus 20 can receive the latest rTWT-SP start time Ts and rTWT-SP duration D in a timely manner.

### 4. Modification and the Like

Note that various modifications of the embodiment described above can be made. For example, in the above-described embodiment, the case where the transmission timing adjustment unit 280 notifies the carrier sense unit 253 of “transmission right acquired” of the transmission wait instruction until there is no carrier sense unit 253 of “transmission right is being acquired” left in the simultaneous transmission candidates has been described, but the embodiment is not limited thereto. For example, the transmission timing adjustment unit 280 may not give a notification of the transmission wait instruction. In this case, the carrier sense unit 253 of “transmission right acquired” waits until notified of the transmission instruction from the transmission timing adjustment unit 280.

In addition, the transmission determination processing according to the embodiment and modification described above can also be stored as a program that can be executed by a processor that is a computer. Furthermore, the program can be stored in a storage medium of an external storage device such as a magnetic disk, an optical disc, or a semiconductor memory for distribution. Then, the processor reads the program stored in the storage medium of the external storage device, and the operation is controlled by the read program, whereby the transmission determination processing can be executed.

Note that the present invention is not limited to the above embodiments, and various modifications can be made in the implementation stage without departing from the gist of the invention. In addition, the embodiments may be implemented in appropriate combination, and in this case, a combined effect can be obtained. Furthermore, the above embodiments include various inventions, and various inventions can be extracted by a combination selected from a plurality of disclosed components. For example, even if some components are deleted from all the components described in the embodiment, a configuration from which the components have been deleted can be extracted as an invention, as long as the problem can be solved and the effects can be achieved.

### REFERENCE SIGNS LIST

1 Communication system
10 Access point
20 Terminal apparatus
30 Network
11, 21 CPU
12, 22 ROM
13, 23 RAM
14, 24 Wireless communication module
15 Wired communication module
25 Display
26 Storage
200 Application execution unit
110, 210 LLC processing unit
120, 220 Data processing unit
130, 230 Management unit
131, 231 Link management information
132, 232 Link management unit
133, 233 Beacon management unit
140, 240 MAC frame processing unit
150, 160, 170, 250, 260, 270 Wireless signal processing unit
180, 280 Transmission timing adjustment unit
251 Classification unit
252 Queue
253 Carrier sense unit
254 Internal collision management unit

1. A transmission station comprising:
a first transmission unit;
a second transmission unit;
a management unit configured to establish, with a reception station, a multi-link in which a first channel is allocated to the first transmission unit and a second channel is allocated to the second transmission unit, and allocate a first service period to the second channel; and
an adjustment unit configured to postpone transmission of first data when a first occupancy period for the first transmission unit to transmit the first data overlaps with the first service period.

2. The transmission station according to claim 1, further comprising:
a third transmission unit,
wherein
the management unit is further configured to allocate a third channel to the third transmission unit to establish the multi-link with the reception station, and set a second service period to the third channel, and
the adjustment unit is configured to postpone transmission of the first data when the first occupancy period overlaps with an earliest service period of the first service period and the second service period.

3. The transmission station according to claim 2, wherein the adjustment unit is configured to execute transmission of the first data when the second transmission unit fails to acquire a transmission right and the first occupancy period does not overlap with the second service period.

4. The transmission station according to claim 2, wherein the adjustment unit is configured to postpone transmission of the first data when the second transmission unit fails to acquire a transmission right and the first occupancy period overlaps with the second service period.

5. The transmission station according to claim 1, wherein after one transmission unit of the first transmission unit and the second transmission unit acquires a transmission right, until the other transmission unit acquires a transmission right, the adjustment unit is configured to cause the one transmission unit to wait to transmit data.

6. The transmission station according to claim 1, wherein
in a case where the first transmission unit acquires a transmission right of the first data, the second transmission unit acquires a transmission right of second data, and the first occupancy period does not overlap with the first service period, the adjustment unit notifies each of the first transmission unit and the second transmission unit of a longest occupancy period of the first occupancy period and a second occupancy period for transmitting the second data, and
the second transmission unit is configured to add padding to the second data so that an end time of the second occupancy period aligns with an end time of the longest occupancy period.

7. The transmission station according to claim 6, wherein the second transmission unit is configured to transmit data having a lower latency than the second data in the first service period.

8. The transmission station according to claim 1, wherein a notification of the first service period is given by a beacon signal.

9. The transmission station according to claim 1, wherein the first occupancy period includes a period of receiving acknowledgement (Ack) from the reception station.

10. A transmission method of a transmission station including a first transmission unit and a second transmission unit, the transmission method comprising:
establishing, with a reception station, a multi-link in which a first channel is allocated to the first transmission unit and a second channel is allocated to the second transmission unit;
allocating a first service period to the second channel; and
postponing transmission of first data when a first occupancy period for the first transmission unit to transmit the first data overlaps with the first service period.

11. A non-transitory computer-readable storage medium storing a transmission program used in a transmission station including a first transmission unit; and a second transmission unit, the program causing a computer to:
establish, with a reception station, a multi-link in which a first channel is allocated to the first transmission unit and a second channel is allocated to the second transmission unit;
allocate a first service period to the second channel; and
postpone transmission of first data when a first occupancy period for the first transmission unit to transmit the first data overlaps with the first service period.
postpone transmission of first data when a first occupancy period for the first transmission unit to transmit the first data overlaps with the first service period.
